(19) United States
(12) Patent Application Publication
(10) Pub. No.: US 2021/0057123 A1
(43) Pub. Date: Feb. 25, 2021

(54) Elements For Mitigating Electron Reflection and Vacuum Electronic Devices Incorporating Elements For Mitigating Electron Reflection

(71) Applicant: Modern Electron, Inc., Bothell, WA (US)

(72) Inventors: Stephen E. Clark, Seattle, WA (US); Roelof E. Groenewald, Bothell, WA (US); Arvind Kannan, Kirkland, WA (US); Hsin-I Lu, Bothell, WA (US); Daniel J. Merthe, Seattle, WA (US); Jason M. Parker, Bothell, WA (US); Alexander J. Pearse, Seattle, WA (US); Peter J. Scherpelz, Seattle, WA (US); Max N. Mankin, Seattle, WA (US); Tony S. Pan, Kirkland, WA (US)

(21) Appl. No.: 16/998,443

(22) Filed: Aug. 20, 2020

Related U.S. Application Data
(60) Provisional application No. 62/891,277, filed on Aug. 24, 2019.

(51) Int. Cl. G21H 1/10; G21C 3/40

(52) U.S. Cl. CPC G21H 1/106; H01J 45/00; G21C 3/40

(57) ABSTRACT

Various disclosed embodiments include elements for mitigating electron reflection in a vacuum electronic device, vacuum electronic devices that incorporate elements for mitigating electron reflection, and methods of fabricating elements for reducing reflection of electrons off an electrode. An illustrative electrode assembly includes an electrode. Elements are configured to reduce reflection of electrons off the electrode.

### BACKGROUND

The statements in this section merely provide background information related to the present disclosure and may not constitute prior art.

Thermionic energy conversion is the direct production of electrical power from heat by thermionic electron emission. A thermionic energy converter (“TEC”) is a vacuum electronic device that includes a hot emitter electrode which thermionically emits electrons over a potential energy barrier and through an inter-electrode plasma to a cooler collector electrode, thereby producing a useful electrical power output.

Resulting electrical current from known TECs, typically on the order of around several amperes per square centimeter of emitter surface, delivers electrical power to a load at a typical potential difference of 0.5 volt-1 volt and a typical thermal efficiency of around 5%-20%, depending on the emitter temperature (1500 K-2000 K) and mode of operation.

In a TEC, the goal is to have the collector electrode absorb all electrons that impact it. However, as is known, in currently known TECs some electrons will “bounce” off the collector electrode instead of being absorbed by the collector electrode. For example and referring to FIG. 1, in currently known TECs an incident electron 1 may be reflected (indicated by arrow 2) off a flat collector electrode (that is, the anode) 3 back to the emitter electrode (that is, the cathode) (not shown in FIG. 1). This “bouncing” off the collector electrode by electrons is known as electron reflection. Electron reflection is a recognized detrimental factor in the operation of currently known TECs.

In addition, these reflected electrons can contribute to space charge. As is known, space charge prevents other electrons from moving from the emitter electrode to the collector electrode or can cause the other electrons to be absorbed by other electrodes in the structure (that are not intended to absorb electrons).

An attempt has been made to address electron reflection by use of a coating of “platinum black” (Pt-black) and other similar metals with rough features that seek to enhance absorption. One shortcoming of Pt-black is that the emitter material is prone to evaporation. As a result, the rough features in Pt-black and similar materials will become covered by evaporated emitter material. The evaporated emitter material is not nearly as rough as Pt-black. As a result, the collector electrode that has been covered by the evaporated emitter material does not have the electron anti-reflection properties when the collector electrode was originally coated with Pt-black.

Another shortcoming of Pt-black is that Pt-black absorbs a significant amount of thermal radiation (that is, visible radiation and infrared radiation from the very hot emitter electrode). This thermal radiation absorption occurs because the Pt-black is very good at absorbing the wavelengths of visible radiation and infrared radiation (thus, Pt-black appears black). However, thermal radiation absorption harms the efficiency of a TEC.

### SUMMARY

Various disclosed embodiments include elements for mitigating electron reflection in a vacuum electronic device, vacuum electronic devices that incorporate elements for mitigating electron reflection, and methods of fabricating elements for reducing reflection of electrons off an electrode.

In an illustrative embodiment, an illustrative electrode assembly includes an electrode. Elements are configured to reduce reflection of electrons off the electrode.

In another illustrative embodiment, an illustrative vacuum electronic device includes an emitter electrode and a collector electrode assembly. The collector electrode assembly includes a collector electrode and elements are configured to reduce reflection of electrons off the collector electrode.

In another illustrative embodiment, an illustrative method of fabricating elements for reducing reflection of electrons off an electrode includes: providing an electrode; and configuring elements to reduce reflection of electrons off the electrode.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Illustrative embodiments are illustrated in referenced figures of the drawings. It is intended that the embodiments and figures disclosed herein are to be considered illustrative rather than restrictive.

FIG. 1 is a side plan view in partial schematic form of a currently known flat collector electrode.

FIG. 2A is a side plan view in partial schematic form of an illustrative electrode with elements for mitigating electron reflection.

FIG. 2B is a side plan view in partial schematic form of an illustrative vacuum electronic device with the electrode and elements of FIG. 2A.

FIG. 3 is a side plan view in partial schematic form of illustrative elements for mitigating electron reflection.

FIG. 4 is a side plan view in partial schematic form of other illustrative elements for mitigating electron reflection.

FIG. 5 is a side plan view in partial schematic form of other illustrative elements for mitigating electron reflection.

FIG. 6 is a side plan view in partial schematic form of an illustrative vacuum electronic device with other illustrative elements for mitigating electron reflection.

FIG. 7 is a scanning electron microscope image of an illustrative collector partitioned into two isolated components.

FIG. 8 is a graph of current collection ratio versus time.

FIG. 9 is a graph of optical reflectance versus wavelength.

FIG. 10 is a flowchart of an illustrative method of fabricating elements for reducing reflection of electrons off an electrode.

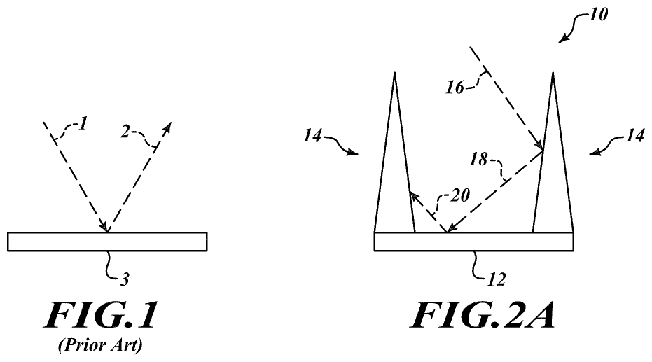

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

By way of overview, various disclosed embodiments include elements for mitigating electron reflection in a vacuum electronic device, vacuum electronic devices that incorporate elements for mitigating electron reflection, and methods of fabricating elements for reducing reflection of electrons off an electrode.

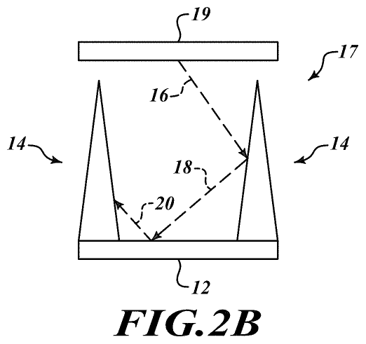

Still by way of overview and referring now to FIG. 2A, in various embodiments an illustrative electrode assembly 10 includes an electrode 12 (such as without limitation a collector electrode). Elements 14 are configured to reduce reflection of electrons 16 off the electrode 12. Referring additionally to FIG. 2B, an illustrative vacuum electronic device 17 includes an emitter electrode 19 that is configured to emit electrons 16. For example, in embodiments when the vacuum electronic device 17 is a TEC, the emitter electrode 19 can emit electrons 16 thermionically. The vacuum electronic device 17 also includes the electrode 12 (in this case—a collector electrode) and the elements 14. As shown in FIGS. 2A and 2B, an incident electron 16 may have multiple reflections (indicated by arrow 18) off the collector electrode 12 and the elements 14. In such embodiments, the incident electron 16 may have multiple reflections 18 before ultimately being absorbed (as indicated by arrow 20), thereby helping contribute to increasing overall probability of collection.

Still by way of overview, in some embodiments the elements 14 may be disposed on the electrode 12 (such as with a coating or with patterned structures) and in some other embodiments the elements 14 may be structures that are patterned in the electrode 12 itself. Regardless, the elements 14 are in electrical communication with the electrode 12. In any such embodiments the result is that the surface of the conducting collector electrode 12 is “roughened” so as to induce one or more bounces 18 of incident electrons 16 on the surface of the conducting collector electrode 12. It will be appreciated that in any such embodiments the roughened surface of the conducting collector electrode 12 (that is provided by the elements 14) can help contribute to increasing overall probability of collection 20 of electrons 16 by the electrode 12 and/or can help contribute to reducing possibly undesirable flux of electrons to other components within a vacuum envelope (not shown) of the vacuum electronic device 17. It will also be appreciated that the roughened surface of the conducting collector electrode 12 (again—that is provided by the elements 14) can help contribute to reducing thermal losses due to incident electromagnetic radiation as well as the effects of material evaporated from the emitter electrode.

Still by way of overview, in various embodiments disclosed elements 14 can help contribute to increasing the fraction of electrons absorbed on the collector electrode 12, thereby helping contribute to reducing the impact of electron reflection. In various embodiments, disclosed elements 14 can help contribute to possibly increasing lifetime and/or efficiency of vacuum electronic devices over currently known vacuum electronic devices that do not mitigate electron reflection.

Now that an overview has been provided, illustrative details will be provided by non-limiting examples given by way of illustration only and not of limitation.

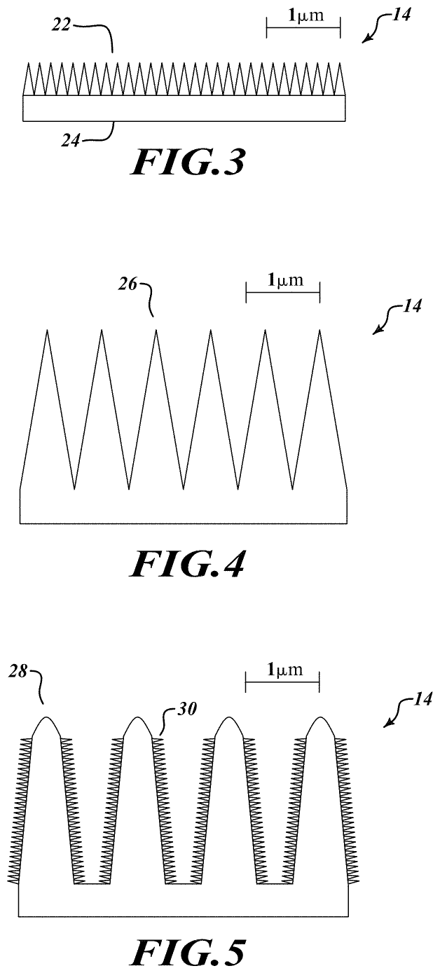

Various non-limiting examples of illustrative elements 14 first will be discussed by way of illustration only and not of limitation. As used herein, the term “element” means at least one structure and/or a coating that is configured to reduce absorption of thermal radiation. For example and referring now to FIG. 3, in various embodiments a porous or trenched conducting layer with high aspect ratio elements 22 is etched into or deposited onto a substrate 24, which is generally but not necessarily conductive. In such embodiments, the size of the pores or trenches suitably is less than the dominant wavelengths of black-body light emanating from the nearby hot emitter. The incident light waves therefore interact with the surface as if it were a simple conducting plane, which reflects the light waves almost totally. Meanwhile, the typical de Broglie wavelength of the incident electrons is much smaller (by at least an order of magnitude), thereby allowing the electrons to enter the openings in the surface with a reduced probability of leaving the surface. It will be appreciated that, in such embodiments and depending on emitter operating conditions, effectiveness of the selectively absorptive surface can be affected by contamination, such as evaporant from the hot emitter, that may be deposited on the surface.

Referring now to FIG. 4, various other embodiments may present increased resilience to emitter evaporation or other deposited contamination. In some such embodiments, high aspect ratio trenches or pits 26 are etched into a conducting surface, or into an insulating or semiconducting surface which is later metallized. In some other such embodiments, pillars or similar structures may be deposited onto these surfaces to create the same configuration. The size of these pores or trenches 26 is on the micron scale or larger. Electrons entering these openings may likely experience multiple possible bounces, thereby helping contribute to increasing net electron absorptivity of the surface. It will be appreciated that, because it is larger in dimension than the elements 22 (FIG. 3), the surface can tolerate more deposited contamination. However, for the same reason, in some such embodiments effective emissivity of the surface may increase (possibly significantly), thereby possibly contributing to a lower overall efficiency of the TEC. It is possible to design the shape, areal coverage, and size of the openings to reduce the effective emissivity for an optimal performance gain by trading off optical absorption (unfavorable) and electron absorption (favorable) on the collector—but it is always greater than that of a planar surface.

Referring additionally to FIG. 5, various embodiments combine some of the elements shown in FIGS. 3 and 4, thereby gaining selective absorptivity while also being resistant to contamination. For example and as shown in FIG. 5, various embodiments use surface patterning on different scales into a single mesoscopic structure. In some such embodiments, a surface pattern 28 similar to that shown in FIG. 4 is fabricated and a smaller scale patterning 30 shown in FIG. 3 is placed onto the nearly vertical walls, thereby helping contribute to reducing the impact of emitter material that is deposited mostly directly normal to the collector surface. Being on the steep incline means that less of this material lands on the finer scale pattern. The larger scale pattern may be optimized to minimize effective emissivity of the surface.

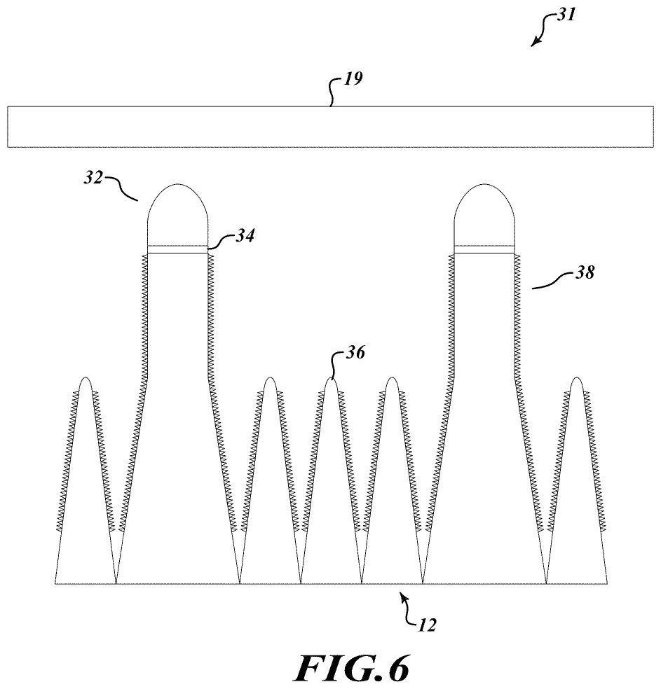

Referring additionally to FIG. 6, current collection in vacuum electronic devices can be enhanced by using grids or gridded-collector architectures, whereby a low fill-factor electrode (grid) is suspended or placed on an insulating barrier over a collector surface and biased at a positive voltage to pull electrons away from the emitter. It will be appreciated that electrons that reflect off the collector surface in this configuration generally may have a high probability of impinging on the high voltage grid, thereby contributing to parasitic power loss. The selectively absorptive surface patterning described above with reference to FIG. 5 can help contribute to mitigating this issue when applied specifically to the surface where electron absorption is desired. For example and as shown in FIG. 6, a vacuum electronic device 31 includes a grid 32 that is interposed between an emitter 19 and a collector 12 and is attached through an insulating layer 34 to the collector surface 12. The collector surface is fabricated with a micron-scale pattern 36 and/or nanometer-scale pattern 38.

It will be appreciated that anti-reflective elements (or coatings or surfaces) are not limited to applications in TECs but can be used in other vacuum electronic devices as desired. For example, another application for anti-reflective elements is in vacuum electronic RF/microwave amplifiers. For instance, anti-reflective elements could help reduce electron reflection from a grid in an inductive output tube (IOT), thereby helping contribute to increasing efficiency of the device and/or preventing reflected electrons from striking other surfaces or otherwise disrupting electron optics in the device. Additionally, electron reflection is known to be a factor in multipaction (a deleterious effect in tube amplifiers). Electron anti-reflection elements can help contribute to reducing the fraction of electrons emitted via multipaction from moving further into the tube and further disrupting operation of the tube. Finally, depressed/multistage collectors in vacuum electronics are not as efficient when electrons reflect from them (because electrons bounce off and strike an electrode that is not optimally suited to absorbing an electron of their energy). In such applications, electron anti-reflective elements could also help contribute to increasing the efficiency of a depressed/multistage electron collector in a vacuum tube amplifier.

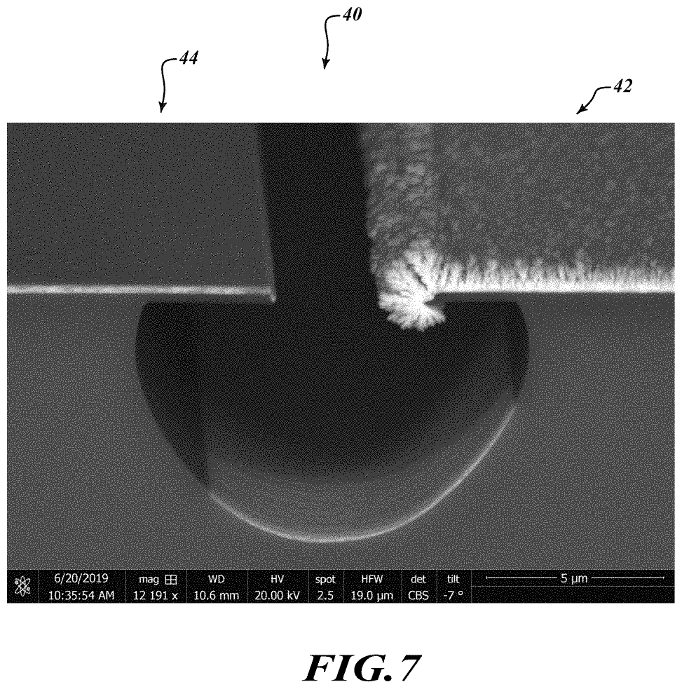

In various embodiments and referring additionally to FIGS. 7-9, in various embodiments a coating may be selectively absorptive as desired and may be selectively deposited on electrically distinct segments of a composite collector. As shown in FIG. 7, in an illustrative embodiment a scanning electron microscope (SEM) image shows a collector 40 partitioned into two isolated components 42 and 44 from a silicon on insulator (SOI) wafer using standard silicon and silicon dioxide etching techniques. The component 42 was then coated with Pt-black via electroplating and the component 44 was evaporatively coated with planar Pt.

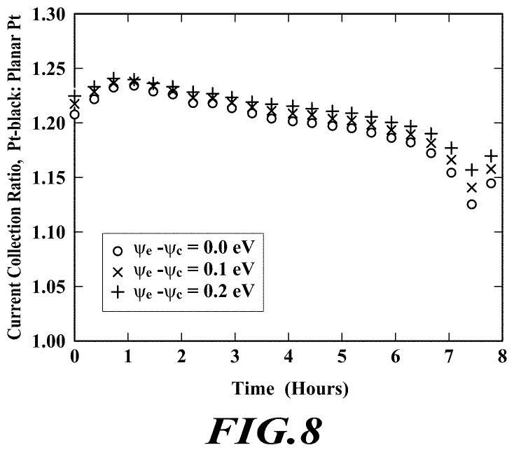

As shown in FIG. 8, a ratio of currents collected by the two components 42 and 44 (FIG. 7) when used simultaneously as part of a TEC are graphed over a test period of 8 hours in the maximum power producing regime (that is, near zero vacuum bias). The “o”, “x”, and “+” symbols correspond to collector-emitter vacuum biases of 0.0, 0.1, and 0.2 eV, respectively, and illustrate the dependence on incident electron energy. The Pt-black coated collector surface in the component 42 collected as much as 24% and at least 13% more current than the planar Pt surface in the component 44 during this interval. With both surface work functions found to have the same work function (about 1.3 eV) within 0.2 eV, the implication is that the Pt-black coating reduces the electron reflectivity leading to the observed higher current collection.

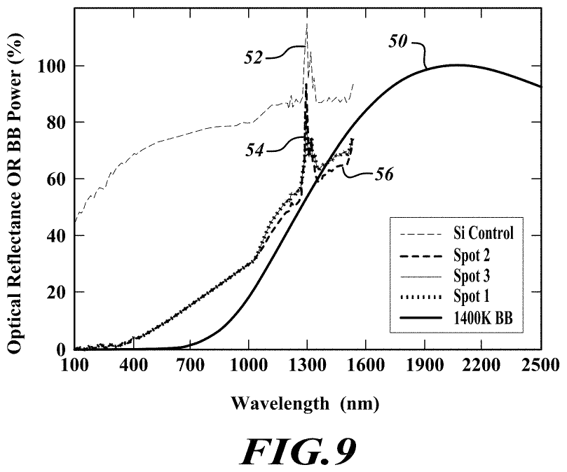

As shown in FIG. 9, a normal reflectance spectrum of a similar coating produced by the same method is shown—but on a single continuous planar surface. A curve 50 is the emission spectrum of a 1400 K black-body, a curve 52 is the reflectance spectrum of a planar silicon control substrate, and curves 54 and 56 are reflectance spectra at various points on the Pt-black coated surface. The curves 50, 52, 54, and 56 show that even though the reflectance of the Pt-black surface is low in the visible wavelengths (hence the black appearance)—it becomes highly reflective (>50%) at the dominant wavelengths of the black-body emissions from a typical hot emitter in a TEC. Hence, this specific coating is selectively absorptive as desired, and can be selectively deposited on electrically distinct segments of a composite collector.

Multi-electrode structures in which a rough coating is selectively applied may help contribute to improvements listed above such as resistance to emitter evaporation and enhanced absorption of electrons. It will be appreciated that this selectively applied coating can also help contribute to improving device efficiency by making it less likely that electrons will land in undesirable locations (because they are not coated with the rough coating and are likely to reflect) and instead more likely they will land in desirable locations (which do have the rough coating applied). If power is not lost because electrons do not land at an undesirable location, then this reduction in electron absorption at undesirable locations can help contribute to improving efficiency of the device by severely curtailing power loss. Finally, the rough coating can be applied selectively to minimize its impact on radiative absorption by applying the rough coating only to areas where electrons are being focused or where the impact on radiative absorption is smallest due to, for example, geometrical factors.

From the above description and the drawing figures, it will be appreciated that multiple aspects can describe rational design of elements (that is, a structure or coating) that can help contribute to enhancing electron absorption while simultaneously reducing the impact of emitter evaporation and/or seeking to optimize reflectivity of thermal radiation. Several such aspects will be discussed below by way of examples given by way of illustration only and not of limitation.

For example, one aspect is using size-specific rough coatings to selectively absorb electrons but to reflect most photons in the infrared and near-infrared part of the spectrum. This can be done because the de Broglie wavelength of electrons is very small (on the order of nanometers), whereas the photons that should be reflected range from about 500 nm to 10 microns. If the characteristic size of the rough coating is around 500 nm or smaller, then the coating can appear as effectively flat to the photons, while still enhancing the absorption of electrons. It will be appreciated that use of size-specific coatings is not currently known in the art. As a result, even though currently-known rough coatings (like Pt-black) may absorb electrons effectively, they will also absorb infrared and near-infrared photons well—which can reduce efficiency of a TEC.

Another aspect is using mesoscopic structures, with characteristic size scales ranging from 2 micron to 1 millimeter, to help enhance the absorption of electrons while increasing resistance to degradation from emitter evaporation. Currently-known approaches are not known to consider scenarios in which emitter evaporation is large and, when it is, very small feature sizes will be covered by the evaporated material. Instead, geometries disclosed herein, such as tall pillars, can help contribute to achieving similar results at larger feature sizes which are robust to emitter evaporation.

Another aspect is coating the mesoscopic structures described above, such as tall pillars, with a rough coating—and especially a size-specific rough coating—to enhance electron absorption and/or seek to optimize radiative heat transfer. The structures and coating work synergistically to absorb electrons by significantly increasing the number of bounces a non-absorbed (i.e. reflected) electron makes on collector surfaces before it can return to the emitter. Furthermore, the rough coatings disclosed herein are more resistant to emitter evaporation than in the case of a rough coating on a flat surface. This resistance results because, as disclosed herein, the surface can be near-perpendicular with regard to the emitter. As a result, very little evaporated material from the emitter can build up on them.

Another aspect is selectively fabricating a rough coating—and especially a size-specific rough coating—on specific electrodes of a multi-electrode device. An example of such a multi-electrode device is one in which a “grid” electrode is held at a positive voltage to steer electrons while another electrode (that is, the collector) is held near zero voltage to absorb electrons. In such a device, it would be desirable to reduce (and seek to minimize) electrons absorbed on the grid. Thus, it may be desirable to selectively deposit the rough coating only on the collector to increase its electron absorption while keeping the reflectivity of the grid to electrons high. More complicated designs of three or more electrodes can be envisioned in which one or more electrodes are coated with the rough coating and one or more electrodes are not. This feature may be especially notable in that it is suitable to fabrication using electrodeposition, wherein a voltage can be applied only to the electrodes to be coated, thereby leading to the rough coating depositing only on those electrodes during the electrodeposition process.

It will be appreciated that the electron anti-reflection coating (rough surface) may also be patterned in selective areas to match electron beam optics. For instance, in the case of a focused electron beam, the coating may be patterned selectively in an area where most of the electrons strike a collector. Similarly, coating vertical walls may impact radiative transfer less than coating horizontal surfaces. In both cases, the device may maintain a flat (that is, optically reflective) surface throughout a significant fraction of its area but may maintain an electron-absorptive surface in the location where that is most beneficial. The tradeoff between optical reflection and electron absorption (that is, the area fraction on which the rough surface is deposited/not deposited) can be optimized to maximize efficiency/power output.

As discussed above, currently known coatings that seek to mitigate electron reflection are not robust to either emitter evaporation or to maintaining high energy conversion efficiency by achieving low emissivity. It will be appreciated that coatings and structures disclosed herein can help contribute to seeking improvements as discussed in the below examples.

First, for size-selective rough coatings, disclosed embodiments can help contribute to maintaining a high reflectivity to thermal radiation (photons in the infrared and near-infrared). A significant portion of heat absorbed by the emitter can be emitted as thermal radiation. If this radiation is absorbed by other parts of the TEC, then efficiency can be reduced. Instead, as much of this radiation as possible should be reflected in order to maintain high efficiency. By default, rough coatings tend to absorb very high amounts of thermal radiation. Size-specific rough coatings significantly improve upon standard rough coatings by avoiding this large absorption of thermal radiation.

Next, for mesoscopic structures, the feature size is significantly larger than the Pt-black and similar coatings used to date. It will be appreciated that feature size is an important factor in determining how robust a structure is to emitter evaporation. If, hypothetically, an emitter evaporated 1 micron of material onto the collector during operation, then feature sizes of 500 nm could be completely covered and rendered ineffective by evaporation, whereas mesoscopic structures of size scale 5 micron or more would only be slightly affected by the same amount of evaporation. This robustness against evaporation can therefore help contribute to a significantly enhanced lifetime or reduced performance degradation over time of the thermionic converter.

Next, for mesoscopic structures coated with a rough coating, if most of the area of the mesoscopic structure includes substantially vertical walls (such as tall, narrow pillars) that are covered with the rough coating, then emitter evaporation may not lead to material building up on these vertical walls—because the walls are perpendicular to the emitter. Also, the combination of large-scale roughness and small-scale roughness may have an even higher absorption of electrons than either alone, which can help contribute to an enhancement in performance.

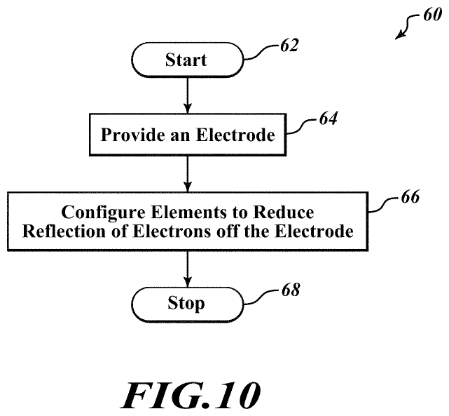

Various embodiments may be fabricated as follows. Referring now to FIG. 10, a method 60 of fabricating elements for reducing reflection of electrons off an electrode starts at a block 62. At a block 64 an electrode is provided. At a block 66 the elements are configured to reduce reflection of electrons off the electrode. The method 60 stops at a block 68.

Regarding fabrication, various embodiments (including without limitation the elements 14, composite gridded-collector devices, simple textured collector devices, TECs, and vacuum electronic devices such as those mentioned above) can be straightforwardly (but not necessarily) fabricated using well-known semiconductor wafer processing techniques such as, without limitation, chemical vapor deposition, physical vapor deposition, atomic layer deposition, plating, evaporating, and sputtering. The micron-scale selectively absorptive patterns can also be fabricated in this manner, but other methods are possible—including laser micromachining and laser-induced pattern surface structure (LIPSS) methods, bombardment by energetic particles (e.g. ion beam, grit blasting), chemical etching, gaseous (dry) etching, and the like.

Several possible methods can be used to produce the nanometer-scale surface texture (either during the fabrication of the larger scale elements or post-fabrication). As a first example, one way to accomplish this post-fabrication is through frustrated electrodeposition. This technique (which is straightforward for those skilled in the art) produces, for example, platinum-black (Pt-black) or nickel-black coatings. Because electrodeposition proceeds by passing current through selected electrodes, it is possible to selectively pattern only the collector portion of the gridded-collector. The use of electrochemical methods is well suited for developing grid-selective and conformal (i.e. easily compatible with non-planar geometry) coatings which are also morphologically optimized on the ˜100-1000 nm size range due to the range of elements which can be produced by modulating the deposition parameters.

As a second example, another option is to differentially metalize the grid and collector such that the collector metal is amenable to dealloying (while the grid metal layer is not). Dealloying of metal alloys, for example that of Cu—Mn in low molarity HCl, is capable of producing highly porous metallic surfaces with tunable pore sizes on the nanometer to micron scales.

As a third example, another option (which would be combined with the micron-scale semiconductor processing) takes advantage of the now well-developed method of nanosphere lithography, whereby a self-assembled layer of polystyrene beads with possible sizes going down to ˜10 nm form a nanometer-scale etching mask on the collector surface to produce arrays of nanospheres on the same scale.

Also, it will be appreciated that textured surfaces in a selective area may be deposited by masking areas to not be coated (via photolithography, kapton tape, or similar techniques), then depositing the coating using any of the above methods, and then removing the mask.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An electrode assembly comprising:
an electrode; and
elements configured to reduce reflection of electrons off the electrode.

2. The electrode assembly of claim 1, wherein:
the electrode includes a collector; and
the elements are further configured to increase absorption of electrons by the collector.

3. The electrode assembly of claim 1, wherein the elements are further configured to reduce absorption of thermal radiation by the collector.

4. The electrode assembly of claim 1, wherein the elements include at least one structure.

5. The electrode assembly of claim 4, wherein the at least one structure includes at least one structure chosen from a structure disposed on the electrode and a structure patterned in the electrode.

6. The electrode assembly of claim 4, wherein the at least one structure has a size less than dominant wavelengths of black-body light incidentable thereupon.

7. The electrode assembly of claim 4, wherein the at least one structure has a size on at least a micron scale.

8. The electrode assembly of claim 4, wherein:
each of a plurality of first structures has a size on at least a micron scale; and
a plurality of second structures are disposed on the plurality of first structures, each of the plurality of second structures having a size less than dominant wavelengths of black-body light incidentable thereupon.

9. The electrode assembly of claim 4, wherein the at least one structure is configured to increase resistance to degradation from emitter evaporation.

10. The electrode assembly of claim 1, wherein the elements include a coating disposed on the electrode, the coating being configured to reduce absorption of thermal radiation.

11. The electrode assembly of claim 10, wherein the coating includes characteristic features that are laterally spaced apart by no more than 500 nm.

12. A vacuum electronic device comprising:
an emitter electrode; and
a collector electrode assembly including:
a collector electrode; and
elements configured to reduce reflection of electrons off the collector electrode.

13. The vacuum electronic device of claim 12, wherein the elements are further configured to increase absorption of electrons by the collector electrode.

14. The vacuum electronic device of claim 12, wherein the elements are further configured to reduce absorption of thermal radiation by the collector electrode.

15. The vacuum electronic device of claim 12, further comprising a grid electrode interposed between the emitter electrode and the collector electrode.

16. The vacuum electronic device of claim 12, wherein the elements include at least one structure.

17. The vacuum electronic device of claim 16, wherein the at least one structure includes at least one structure chosen from a structure disposed on the collector electrode and a structure patterned in the collector electrode.

18. The vacuum electronic device of claim 16, wherein the at least one structure has a size less than dominant wavelengths of black-body light incidentable thereupon.

19. The vacuum electronic device of claim 16, wherein the at least one structure has a size on at least a micron scale.

20. The vacuum electronic device of claim 16, wherein:
each of a plurality of first structures has a size on at least a micron scale; and
a plurality of second structures are disposed on the plurality of first structures, each of the plurality of second structures having a size less than dominant wavelengths of black-body light incidentable thereupon.

21. The vacuum electronic device of claim 16, wherein the at least one structure is configured to increase resistance to degradation from emitter evaporation.

22. The vacuum electronic device of claim 12, wherein the elements include a coating disposed on the collector electrode, the coating being configured to reduce absorption of thermal radiation.

23. The vacuum electronic device of claim 22, wherein the coating includes characteristic features that are laterally spaced apart by no more than 500 nm.

24. A method of fabricating an electrode assembly, the method comprising:
providing an electrode; and
configuring elements to reduce reflection of electrons off the electrode.

25. The method of claim 24, further comprising configuring the elements to increase absorption of electrons by the electrode.

26. The method of claim 24, further comprising configuring the elements to reduce absorption of thermal radiation by the electrode.

27. The method of claim 24, wherein configuring elements to reduce reflection of electrons off the electrode includes configuring at least one structure to reduce reflection of electrons off the electrode.

28. The method of claim 27, wherein configuring at least one structure to reduce reflection of electrons off the electrode includes disposing the at least one structure on the electrode.

29. The method of claim 28, wherein disposing the at least one structure on the electrode includes depositing the at least one structure on the electrode.

30. The method of claim 28, wherein depositing the at least one structure on the electrode is performed by a process chosen from frustrated electrodeposition, chemical vapor deposition, physical vapor deposition, atomic layer deposition, plating, evaporating, and sputtering.

31. The method of claim 27, wherein configuring at least one structure to reduce reflection of electrons off the electrode includes patterning the at least one structure in the electrode.

32. The method of claim 24, wherein configuring elements to reduce reflection of electrons off the electrode includes configuring at least one coating to reduce reflection of electrons off the electrode, the coating being further configured to reduce absorption of thermal radiation.

33. The method of claim 32, wherein configuring at least one coating to reduce reflection of electrons off the electrode includes disposing a coating on the electrode.

34. The method of claim 33, wherein disposing a coating on the electrode includes depositing a coating on the electrode.

35. The method of claim 34, wherein depositing a coating on the electrode is performed by a process chosen from frustrated electrodeposition, chemical vapor deposition, physical vapor deposition, atomic layer deposition, plating, evaporating, and sputtering.

36. The method of claim 33, wherein disposing a coating on the electrode includes de-alloying the electrode.
